(19) United States
(12) Patent Application Publication
(10) Pub. No.: US 2012/0002148 A1
(43) Pub. Date: Jan. 5, 2012

(54) LIQUID CRYSTAL DISPLAY PANEL

(75) Inventors: Chia-Hsuan Pai, Taipei City (TW); Te-Sheng Chen, Hsinchu County (TW); Te-Wei Chan, Hsinchu County (TW); Wen-Hao Hsu, Hsinchu County (TW); Hsi-Chien Lin, Keelung City (TW); Shih-Chi Tsai, Taipei City (TW); Chung-Yi Chiu, Hsinchu County (TW)

(73) Assignee: AU OPTRONICS CORPORATION, Hsinchu (TW)

(21) Appl. No.: 12/869,756

(22) Filed: Aug. 27, 2010

(30) Foreign Application Priority Data
Jun. 30, 2010 (TW) 99121480

(51) Int. Cl. G02F 1/1335

(52) U.S. Cl. 349/117

(57) ABSTRACT

A liquid crystal display panel including an active device array substrate, an opposite substrate, and a liquid crystal layer is provided. The active device array substrate includes a plurality of pixel electrodes and each of the pixel electrodes includes a plurality of sets of stripe patterns extending along different directions. Each of the stripe patterns has a width of L and a space between two neighboring stripe patterns is S. The opposite substrate is disposed over the active device array substrate. The liquid crystal layer is disposed between the active device array substrate and the opposite substrate. A cell gap between the active device array substrate and the opposite substrate is d, birefringence of the liquid crystal layer is Δn, and dielectric anisotropy of the liquid crystal layer is Δ∈, wherein S, d, Δn, and Δ∈ comply with the inequality: S/|Δ∈|≦2.8×Δn×d.

### CROSS-REFERENCE TO RELATED APPLICATION

This application claims the priority benefit of Taiwan application serial no. 99121480, filed on Jun. 30, 2010. The entirety the above-mentioned patent application is hereby incorporated by reference herein and made a part of specification.

### BACKGROUND

1. Field of the Invention

The invention relates to a liquid crystal display panel. More particularly, the invention relates to a polymer stabilized alignment (PSA) liquid crystal display panel.

2. Description of Related Art

In development of display technology, with progress of photoelectric technology and semiconductor manufacturing technology, liquid crystal displays (LCDs) having advantages of high image quality, good space utilization efficiency, low power consumption, and no irradiation, etc. become popular in the market.

During a fabrication process of an LCD panel, alignment films are formed on two substrates, so that the liquid crystal molecules may have specific orientation. According to a conventional method of forming the alignment films, an alignment material is first coated, and then an alignment process is performed to the alignment material. The alignment process can be a contact alignment process or a non-contact alignment process. Although the non-contact alignment process can resolve problems of static electricity and particle pollution, etc. occurred in the contact alignment process, a problem of inadequate anchoring energy of an alignment surface is generally occurred. If the anchoring energy of the alignment surface is inadequate, the LCD panel probably have a poor display quality. To resolve the above problem, a polymer stabilized alignment (PSA) technique is developed, by which an appropriate amount of monomer is doped in the liquid crystal, and then the liquid crystal doped with the monomer is heated to reach an isotropy state. Then, when the mixture of the liquid crystal and the monomer is cooled to a room temperature, the liquid crystal molecules return back to a nematic state. Now, the mixture of the liquid crystal and the monomer is injected to a liquid crystal cell and a voltage is applied thereto. When the voltage is applied to ensure the liquid crystal molecules orientating stably, the monomer is polymerised to form polymer layers by irradiation of ultraviolet light or heating, so as to achieve stabilized alignment purpose.

Generally, a pixel electrode in the PSA LCD panel includes a plurality of sets of stripe patterns extending along different directions, and an alignment slit is formed between two neighboring stripe patterns, and the stripe patterns extending along different directions may control orientation of the liquid crystal molecules, so as to achieve a wide-viewing angle effect.

To further enhance a response speed of the PSA LCD panel, a cell gap of the LCD panel can be reduced. However, when the cell gap of the LCD panel is reduced, the liquid crystal efficiency of the LCD panel is accordingly reduced. For example, when the cell gap of the PSA LCD panel is reduced, due to twist in azimuthal angle of the liquid crystal molecules, dark lines (disclination) may occurred on an area corresponding to the alignment slit, and the dark lines (disclination) may lead to deterioration of transmittance of the LCD panel. Therefore, how to simultaneously increase the response speed and the transmittance of the LCD panel is an important issue.

### SUMMARY

The invention is directed to a liquid crystal display (LCD) panel having good liquid crystal efficiency (transmittance).

The invention provides a LCD panel including an active device array substrate, an opposite substrate, and a liquid crystal layer. The active device array substrate includes a plurality of pixel electrodes, and each of the pixel electrodes includes a plurality of sets of stripe patterns extending along different directions. Each of the stripe patterns has a width of L, and a space between two neighboring stripe patterns is S. The opposite substrate is disposed over the active device array substrate. The liquid crystal layer is disposed between the active device array substrate and the opposite substrate. A cell gap between the active device array substrate and the opposite substrate is d, birefringence of the liquid crystal layer is Δn, and dielectric anisotropy of the liquid crystal layer is Δ∈, wherein S, d, Δn, and Δ∈ comply with the following inequality: S/|Δ∈|≦2.8×Δn×d.

In an embodiment of the invention, the cell gap d is smaller than 3.5 μm. In other words, the LCD panel has relatively small cell gap, for example, 2 μm≦d≦3.5 μm, or 1.5 μm≦d≦3.5 μm.

In an embodiment of the invention, 0<S≦d−0.3 μm, for example, 0<S≦4 μm, or 1.5 μm<S≦3.5 μm.

In an embodiment of the invention, the LCD panel further includes a first alignment film and a first polymer layer, wherein the first alignment film covers the pixel electrodes, and the first polymer layer is located between the first alignment film and the liquid crystal layer.

In an embodiment of the invention, the opposite substrate includes a common electrode.

In an embodiment of the invention, the LCD panel may further includes a second alignment film and a second polymer layer, wherein the second alignment film covers the common electrode, and the second polymer layer is located between the second alignment film and the liquid crystal layer.

In an embodiment of the invention, the active device array substrate further includes a plurality of active devices, and each of the active devices is electrically connected to one of the pixel electrodes.

In an embodiment of the invention, L/S is about 3.5 μm/2.5 μm.

In an embodiment of the invention, 2.5≦Δ∈≦5.5.

In an embodiment of the invention, 0.05≦Δn≦0.15.

According to the above descriptions, by adjusting the space S between two neighboring stripe patterns in the pixel electrode, and selecting suitable liquid crystal material (Δ∈, Δn and d) in order to comply with the inequality S/|Δ∈|≦2.8×Δn×d, both of the response speed and the liquid crystal efficiency (transmittance) of the LCD panel can be taken into consideration.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a cross-sectional view of a polymer stabilized alignment (PSA) liquid crystal display (LCD) panel according to an embodiment of the invention.

FIG. 1B is a schematic diagram of a pixel electrode according to an embodiment of the invention.

FIG. 2A is a schematic diagram illustrating an active device array substrate according to an embodiment of the invention.

FIG. 2B is a schematic diagram illustrating an opposite substrate according to an embodiment of the invention.

### DETAILED DESCRIPTION OF DISCLOSED EMBODIMENTS

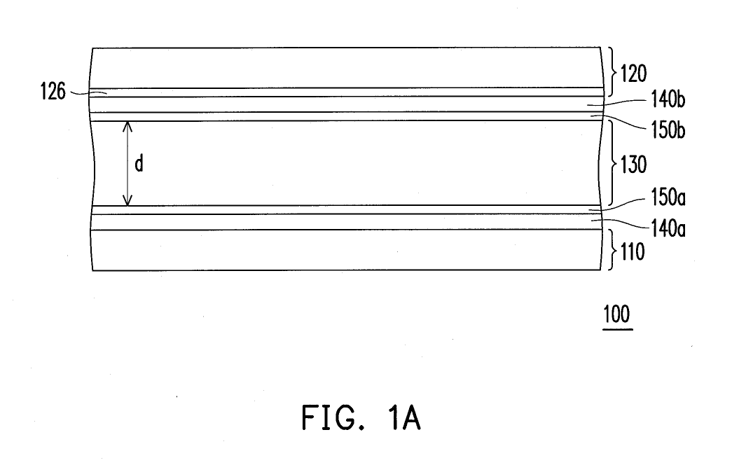

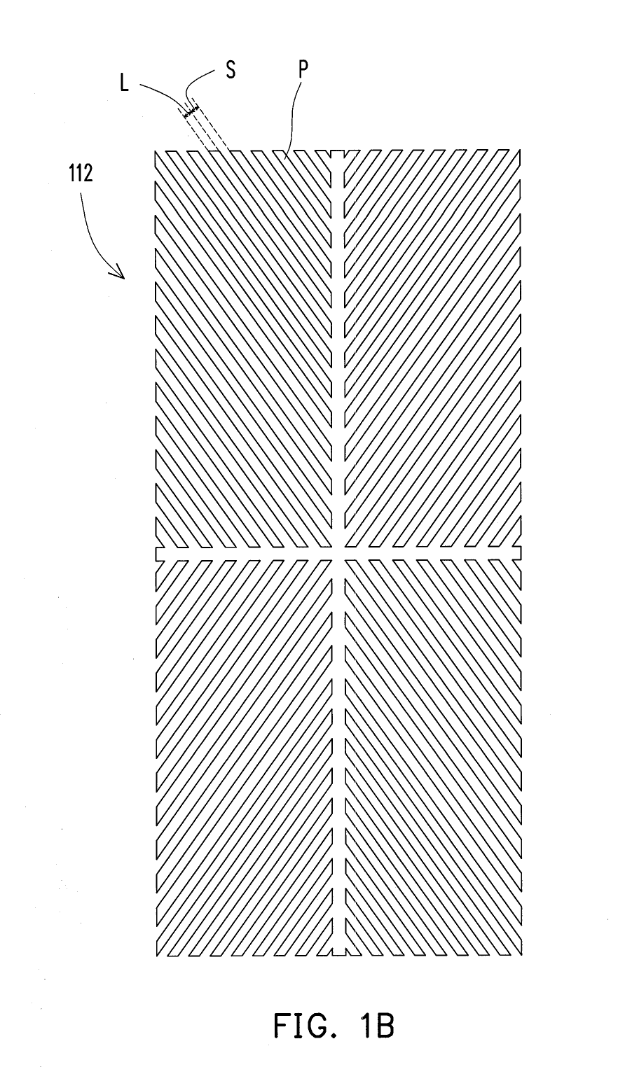

FIG. 1A is a cross-sectional view of a polymer stabilized alignment (PSA) liquid crystal display (LCD) panel according to an embodiment of the invention, and FIG. 1B is a schematic diagram of a pixel electrode according to an embodiment of the invention. Referring to FIG. 1A and FIG. 1B, the PSA LCD panel 100 of the present embodiment includes an active device array substrate 110, an opposite substrate 120, and a liquid crystal layer 130. The active device array substrate 110 includes a plurality of pixel electrodes 112, and each of the pixel electrodes 112 includes a plurality of sets of stripe patterns P extending along different directions. Each of the stripe patterns P has a width of L, and a space between two neighboring stripe patterns P is S. The opposite substrate 120 is disposed over the active device array substrate 110. The liquid crystal layer 130 is disposed between the active device array substrate 110 and the opposite substrate 120. A cell gap between the active device array substrate 110 and the opposite substrate 120 is d, i.e. a thickness of the liquid crystal layer 130 is substantially equal to d. Moreover, birefringence of the liquid crystal layer 130 is Δn, and dielectric anisotropy of the liquid crystal layer 130 is Δ∈. In the present embodiment, the parameters S, d, Δn, and Δ∈ comply with the following inequality (1):

S/|Δ∈|≦2.8×Δn×d (1)

Referring to FIG. 1A and FIG. 1B, the cell gap d is, for example, smaller than 3.5 μm. In other words, the PSA LCD panel 100 of the present embodiment has relatively small cell gap (generally, d≦3.5 μm), for example, 2 μm≦d≦3.5 μm, or 1.5 μm≦d≦3.5 μm. Moreover, the dielectric anisotropy Δ∈ and the birefringence Δn of the liquid crystal layer 130 comply with following inequalities (2) and (3):

2.5≦Δ∈≦5.5 (2)

0.05≦Δn≦0.15 (3)

In the present embodiment, 0<S≦d−0.3 μm, for example, 0<S≦3.2 μm, or 1.5 μm<S≦3.2 μm. In an applicable embodiment, L/S is about 3.5 μm/2.5 μm or 3.8 μm/2.2 μm, though the invention is not limited thereto. In other embodiments, L/S can also be 5 μm/3 μm, 4 μm/3 μm, 4 μm/2.5 μm, and 3 μm/2 μm, etc.

Compared a situation that L/S is 5 μm/3 μm, Δn=0.091 and Δ∈=−3.8 (the transmittance is defined to be 100%), when L/S is 3.5 μm/2.5 μm, Δn=0.104 and Δ∈=−3.1, the transmittance is 101.3%, and when L/S is 3.8 μm/2.2 μm, Δn=0.104 and Δ∈=−3.1, the transmittance is 100.03% as that shown in a following table. It should be noticed that when L/S is 5 μm/3 μm, Δn=0.104 and Δ∈=−3.1 (which are not comply with the inequality S/|Δ∈|≦2.8×Δn×d), the transmittance is only 93%.

| d | Δ n | Δε | L/S | transmittance |
|---|---|---|---|---|
| 3.8 μm | 0.091 | −3.8 | 5 μm/3 μm | 100.0% |
| 3.3 μm | 0.104 | −3.1 | 5 μm/3 μm | 93.0% |
| 3.3 μm | 0.104 | −3.1 | 3.5 μm/2.5 μm | 101.3% |
| 3.3 μm | 0.104 | −3.1 | 3.8 μm/2.2 μm | 100.03% |

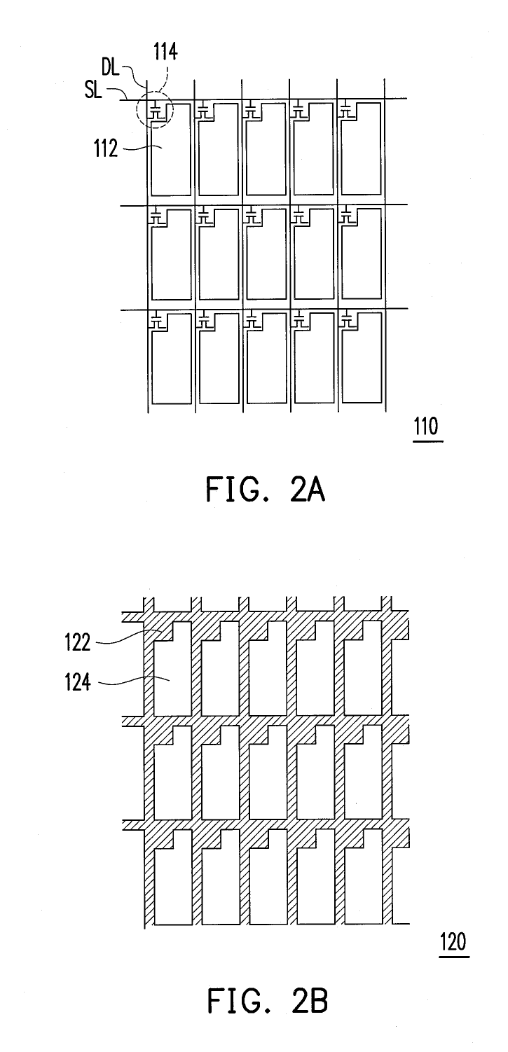

FIG. 2A is a schematic diagram illustrating an active device array substrate according to an embodiment of the invention. Referring to FIG. 1A and FIG. 2A, in the present embodiment, the active device array substrate 110 includes a plurality of scan lines SL, a plurality of data lines DL, a plurality of pixel electrodes 112 and a plurality of active devices 114, wherein the scan lines SL and the data lines DL are interlaced to define a plurality of pixel regions (not shown), and each of the pixel regions (not shown) includes at least one pixel electrode 112 and at least one active device 114, and each of the pixel electrodes 112 is electrically connected to the corresponding scan line SL and data line DL through the active device 114. For example, the active device array substrate 110 is a thin-film transistor (TFT) array substrate.

FIG. 2B is a schematic diagram illustrating an opposite substrate according to an embodiment of the invention. Referring to FIG. 1A and FIG. 2B, in the present embodiment, the opposite substrate 120 includes a light-shielding layer 122, a plurality of color filter thin films 124 and a common electrode 126 (shown in FIG. 1A). In other words, the opposite substrate 120 is a color filter substrate. It should be noticed that the light shielding layer 122 and the color filter thin films 124 on the opposite substrate 120 are selective components. In detail, when the active device array substrate 110 is fabricated according to a COA technique, the color filter thin films 124 are not fabricated on the opposite substrate 120, and when the active device array substrate 110 is fabricated according to a BOA technique, the light-shielding layer 122 and the color filter thin films 124 are not fabricated on the opposite substrate 120.

During a process of fabricating the PSA LCD panel 100, to ensure that the liquid crystal molecules in the liquid crystal layer 130 being aligned stably, a first method thereof is to dope an appropriate amount of monomer in the liquid crystal, and then the liquid crystal doped with the monomer is heated to reach an isotropy state. Then, when the mixture of the liquid crystal and the monomer is cooled to a room temperature, the liquid crystal molecules return back to a nematic state. At this time, the mixture of the liquid crystal and the monomer is injected to a liquid crystal cell and a voltage is applied thereto, wherein the liquid crystal cell includes the active device array substrate 110 and the opposite substrate 120 and a cell-gap is existed between the active device array substrate 110 and the opposite substrate 120. When the voltage is applied to ensure the liquid crystal molecules orientating stably, the monomer is polymerised to form a polymer layer by ultraviolet light or heating. According to a second method, the monomer is not doped in the liquid crystal layer 130, and the liquid crystal layer 130 without the monomer is injected in the liquid crystal cell, wherein the liquid crystal cell includes the active device array substrate 110 and the opposite substrate 120 and a cell-gap is existed between the active device array substrate 110 and the opposite substrate 120. A first alignment mixture film (not shown) and a second alignment mixture film are formed on surfaces of the active device array substrate 110 and the opposite substrate 120 respectively. Particularly, besides containing alignment material, the first alignment mixture film (not shown) and the second alignment mixture film (not shown) are also doped with the monomer. Therefore, when the voltage is applied to the liquid crystal cell and the monomer is polymerised by ultraviolet light or heating, the monomer is polymerised to form the polymer layers on surfaces of the first alignment mixture film (not shown) and the second alignment mixture film (not shown). Namely, the alignment material of the first alignment mixture film (not shown) and the second alignment mixture film (not shown) respectively form a first alignment film 140a and a second alignment film 140b, and the polymer layers polymerised by the doped monomer are respectively a first polymer layer 150a and a second polymer layer 150b, which are respectively located on surfaces of the first alignment film 140a and the second alignment film 140b or respectively located on surfaces of the first alignment film 140a and the second alignment film 140b, as that shown in FIG. 1A. Moreover, a method of injecting the liquid crystal layer 130 in the liquid crystal cell includes vacuum injection and one drop filling (ODF). In the present embodiment, the vacuum injection is taken as an example, though the invention is not limited thereto. According to FIG. 1A, it is known that the PSA LCD panel 100 of the present embodiment further includes the first alignment film 140a, the second alignment film 140b, the first polymer layer 150a and the second polymer layer 150b, wherein the first alignment film 140a covers the active device array substrate 110, the second alignment film 140b covers the opposite substrate 120. The first polymer layer 150a is located between the first alignment film 140a and the liquid crystal layer 130 for stabilizing an alignment state of the liquid crystal molecules close to the first alignment film 140a, and the second polymer layer 150b is located between the second alignment film 140b and the liquid crystal layer 130 for stabilizing the alignment state of the liquid crystal molecules close to the second alignment film 140b.

According to the above descriptions, by adjusting the space S between two neighboring stripe patterns in the pixel electrode, and selecting suitable liquid crystal material (Δ∈, Δn and d) in order to comply with the inequality S/|Δ∈|≦2.8×Δn×d, both of the response speed and the liquid crystal efficiency (transmittance) of the LCD panel are taken into consideration.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A liquid crystal display panel, comprising:
an active device array substrate comprising a plurality of pixel electrodes, wherein each of the pixel electrodes comprises a plurality of sets of stripe patterns extending along different directions, and each of the stripe patterns has a width of L, and a space between two neighboring stripe patterns is S;
an opposite substrate disposed over the active device array substrate; and
a liquid crystal layer disposed between the active device array substrate and the opposite substrate, wherein a cell gap between the active device array substrate and the opposite substrate is d, birefringence of the liquid crystal layer is Δn, and dielectric anisotropy of the liquid crystal layer is Δ∈, and S/|Δ∈|≦2.8×Δn×d.

2. The liquid crystal display panel as claimed in claim 1, wherein 2 μm≦d≦3.5 μm.

3. The liquid crystal display panel as claimed in claim 1, wherein 1.5 μm≦d≦3.5 μm.

4. The liquid crystal display panel as claimed in claim 1, wherein 0<S≦d−0.3 μm.

5. The liquid crystal display panel as claimed in claim 1, wherein 0<S≦4 μm.

6. The liquid crystal display panel as claimed in claim 1, wherein 1.5 μm<S≦3.5 μm.

7. The liquid crystal display panel as claimed in claim 1, further comprising:
a first alignment film covering the pixel electrodes; and
a first polymer layer located between the first alignment film and the liquid crystal layer.

8. The liquid crystal display panel as claimed in claim 1, wherein the opposite substrate comprises a common electrode.

9. The liquid crystal display panel as claimed in claim 1, further comprising:
a second alignment film covering the common electrode; and
a second polymer layer located between the second alignment film and the liquid crystal layer.

10. The liquid crystal display panel as claimed in claim 1, wherein the active device array substrate further comprises a plurality of active devices, and each of the active devices is electrically connected to one of the pixel electrodes respectively.

11. The liquid crystal display panel as claimed in claim 1, wherein L/S is about 3.5 μm/2.5 μm.

12. The liquid crystal display panel as claimed in claim 1, wherein 2.5≦Δ∈≦5.5.

13. The liquid crystal display panel as claimed in claim 1, wherein 0.05≦Δn≦0.15.
